(19) United States
(12) Patent Application Publication
(10) Pub. No.: US 2025/0327161 A1
(43) Pub. Date: Oct. 23, 2025

(54) METHOD OF LOW-TEMPERATURE HEAT TREATMENT FOR AGE-HARDENING ALUMINIUM ALLOY WITH HIGH PROPERTIES

(71) Applicant: JIMEI UNIVERSITY, Xiamen (CN)

(72) Inventors: Wenhui LIU, Xiamen (CN); Xuefeng DING, Xiamen (CN); Xiao LIU, Xiamen (CN); Yufeng SONG, Xiamen (CN); Fan YE, Xiamen (CN); Hao HUANG, Xiamen (CN); Jianfeng CAO, Xiamen (CN)

(73) Assignee: JIMEI UNIVERSITY, Xiamen (CN)

(21) Appl. No.: 19/023,372

(22) Filed: Jan. 16, 2025

(30) Foreign Application Priority Data
Apr. 18, 2024 (CN) 202410471911.6

(51) Int. Cl. C22F 1/00; C22F 1/04

(52) U.S. Cl. CPC C22F 1/002; C22F 1/04

(57) ABSTRACT

A method of low-temperature heat treatment for an age-hardening aluminium alloy with high properties relates to the technical field of metal material treatment. The method of low-temperature heat treatment for the age-hardening aluminium alloy with high properties includes: performing a solid solution treatment, a quenching treatment, a cryogenic treatment, and a low-temperature aging treatment on an aluminium alloy. When the aluminum alloy after the solid solution and quenching treatment is subjected to a low-temperature cryogenic treatment and a sub-low-temperature aging treatment, it can cause dislocation multiplication and cold-induced compressive stress, so as to obtain fine intragranular precipitates and discontinuous precipitates at the grain boundary, which improves the tensile strength, elongation and corrosion resistance properties of the age-hardening aluminium alloy.

### CROSS REFERENCE TO THE RELATED APPLICATIONS

This application is based upon and claims priority to Chinese Patent Application No. 202410471911.6, filed on Apr. 18, 2024, the entire contents of which are incorporated herein by reference.

### TECHNICAL FIELD

The present disclosure relates to the technical field of metal material treatment, and in particular, to a method of low-temperature heat treatment for an age-hardening aluminium alloy with high properties.

### BACKGROUND

2 series, 6 series and 7 series age-hardening aluminium alloys are the preferred material for lightweight in aerospace, transportation, national defense and military industries due to their excellent properties such as low density, high specific strength and specific stiffness, good impact resistance performance, corrosion resistance, easy surface coloring and easy recovery. Frequently, the properties of aluminum alloys are improved by aging treatment processes like T6, T7X, T87, T614, T616 and so forth in the field. T614 interrupted aging process disclosed by CN1507501A can obtain higher strength and toughness than T6 aluminum alloy, however, the low temperature aging time of this method is too long, which is difficult to be applied in a wide range of industrial applications; and CN115386816A disclosed a deep cryogenic-re-aging process including steps of pre-aging, deep cryogenic, and re-aging for improving the strength and toughness of aluminum alloy, but the process is relatively complicated. Therefore, it is of great significance to develop a heat treatment process of the aluminum alloy that can improve the properties of aluminum alloy, as well as having simple processes, and being suitable for industrial application.

### SUMMARY

An objective of the present disclosure is to provide a method of low-temperature heat treatment for an age-hardening aluminium alloy with high properties, to improve the tensile strength, elongation and corrosion resistance of the aluminum alloy, and simplify the treatment method.

In order to achieve the above effects, the present disclosure adopts the following technical solutions.

A method of low-temperature heat treatment for an age-hardening aluminium alloy with high properties includes the following steps:
performing a solid solution treatment, a quenching treatment, a low-temperature cryogenic treatment, and a sub-low-temperature aging treatment on an aluminum alloy in turn; and
a temperature of the low-temperature cryogenic treatment is −196° C. to −70° C., with a time of 0.5 h to 5 h; and a temperature of the sub-low-temperature aging treatment is 20° C. to 80° C., with a time of 120 h to 480 h.

Optionally, the aluminum alloy includes 2XXX series aluminum alloy, 6XXX series aluminum alloy or 7XXX series aluminum alloy.

Optionally, a temperature of the solid solution treatment is 450° C. to 570° C., with a time of 0.5 h to 5 h.

Optionally, a temperature of the solid solution treatment is 470° C. to 550° C., with a time of 1 h to 4 h.

Optionally, a mode of the quenching treatment is water quenching, and a temperature of the water quenching temperature is 5° C. to 30° C.

Optionally, a temperature of the low-temperature cryogenic treatment is −196° C. to −100° C., with a time of 1 h to 4.5 h.

Optionally, a temperature of the sub-low-temperature aging treatment is 50° C. to 75° C., with a time of 150 h to 300 h.

The present disclosure provides a method of low-temperature heat treatment for an age-hardening aluminium alloy with high properties. According to the method, a solid solution treatment, a quenching treatment, a low-temperature cryogenic treatment, and a sub-low-temperature aging treatment are performed on an aluminum alloy in turn. Wherein, the supersaturated solid solution is obtained by solid solution and water quenching, and low-temperature cryogenic treatment can cause dislocation multiplication; and compared with conventional aging temperature, the sub-low-temperature aging can increase the supersaturation of the matrix and increase the nucleation points, thus obtaining fine intragranular precipitates, and at the same time, the diffusion of solute atoms towards the grain boundary and subgrain boundary decreases. Moreover, the release of cold-induced compressive stress generated by low-temperature cryogenic treatment can increase the spacing between n phases at the grain boundary, thereby forming discontinuous precipitates at the grain boundary, which improves the tensile strength, elongation and corrosion resistance properties of the age-hardening aluminium alloy.

The method of low-temperature heat treatment for the aluminum alloy provided by the present disclosure is simple in process, convenient in operation and easy to realize industrialization.

### BRIEF DESCRIPTION OF THE DRAWINGS

FIG. 1 is a flow diagram of a method of low-temperature heat treatment for an age-hardening aluminium alloy with high properties described in Embodiments 1 to 3 of the present disclosure;

FIG. 2 shows age-hardening curves of the treated 7A52 aluminum alloy in Embodiment 3 and Comparison Example 3;

FIG. 3 is a microstructure diagram of the treated 7A52 aluminum alloy in Embodiment 3;

FIG. 4 is a microstructure diagram of the treated 7A52 aluminum alloy in Comparison Example 3;

FIG. 5 is a corrosion morphology diagram of the treated 7A52 aluminum alloy in Embodiment 3; and

FIG. 6 is a corrosion morphology diagram of the treated 7A52 aluminum alloy in Comparison Example 3.

### DETAILED DESCRIPTION OF THE EMBODIMENTS

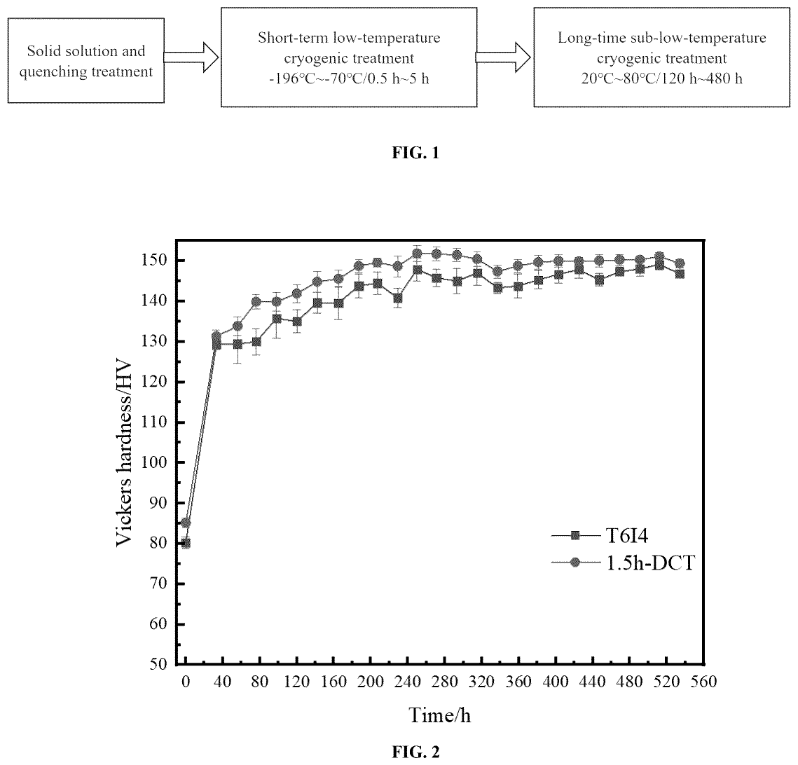

As shown in FIG. 1, the present disclosure provides a method of low-temperature heat treatment for an age-hardening aluminium alloy with high properties, including the following steps:
a solid solution treatment, a quenching treatment, a low-temperature cryogenic treatment, and a sub-low-temperature aging treatment are performed on an aluminum alloy in turn; and
a temperature of the low-temperature cryogenic treatment is −196° C. to −70° C., with a time of 0.5 h to 5 h; and a temperature of the sub-low-temperature aging treatment is 20° C. to 80° C., with a time of 120 h to 480 h.

In the present disclosure, the aluminum alloy preferably includes 2XXX series aluminum alloy, 6XXX series aluminum alloy or 7XXX series aluminum alloy; the aluminum alloys in the present disclosure are all conventional aluminum alloys in this field, and their sources are not specially limited.

In the present disclosure, a temperature of the solid solution treatment is preferably 450° C. to 570° C., and further preferably 470° C. to 530° C.; and a time of the solid solution treatment is preferably 0.5 h to 5 h, further preferably 1 h to 4 h, and more further preferably 2 h to 3 h.

In the present disclosure, a mode of the quenching treatment is water quenching, and a temperature of the water quenching temperature is preferably 5° C. to 30° C., and further preferably 20° C. to 25° C.

In the present disclosure, a temperature of the low-temperature cryogenic treatment is preferably −196° C. to −100° C., and further preferably −180° C. to −120° C.; and a time of the low-temperature cryogenic treatment is preferably 1 h to 4.5 h, and further preferably 1.5 h to 4 h, and more further preferably 2 h to 3 h.

In the present disclosure, a temperature of the sub-low-temperature aging treatment is preferably 50° C. to 75° C., and further preferably 60° C. to 65° C.; and a time of the sub-low-temperature aging treatment is preferably 150 h to 300 h, and further preferably 200 h to 250 h.

In the following, the technical solutions provided by the present disclosure are described in detail in combination with the embodiments, but they cannot be understood as limiting the scope of protection of the present disclosure.

### Embodiment 1

The meltcasted as-cast Al-6.82Si—0.34 Mg alloy was solution treated at 530° C. for 3 h, quenching with 25° C. water, subsequently being placed at −196° C. for low-temperature cryogenic treatment for 2 h; and then the sub-low-temperature aging treatment was performed at 50° C. for 200 h.

### Embodiment 2

The 7A62 aluminum alloy was solution treated at 470° C. for 2 h, quenching with 25° C. water, subsequently being placed at −120° C. for low-temperature cryogenic treatment for 2 h; and then the sub-low-temperature aging treatment was performed at 60° C. for 200 h.

### Embodiment 3

The 7A52 aluminum alloy was solution treated at 470° C. for 2 h, quenching with 20° C. water, subsequently being placed at −196° C. for low-temperature cryogenic treatment for 1.5 h; and then the sub-low-temperature aging treatment was performed at 65° C. for 250 h.

### Comparison Example 1

The T6I4 treatment was performed on the as-cast Al-6.82Si-0.34 Mg alloy described in Embodiment 1, specifically as follows: the as-cast Al-6.82Si-0.34 Mg alloy was solution treated at 530° C. for 3 h, quenching with 25° C. water, and subsequently maintained at 160° C. for 1.5 h and at 50° C. for 720 h in turn to complete the aging treatment.

### Comparison Example 2

The T6 treatment was performed on the 7A62 aluminum alloy described in Embodiment 2, specifically as follows: the 7A62 aluminum alloy was solution treated at 470° C. for 2 h, quenching with 25° C. water, and subsequently maintained at 120° C. for 24 h to complete the aging treatment.

### Comparison Example 3

The T614 treatment was performed on the 7A52 aluminum alloy described in Embodiment 3, specifically as follows: the 7A52 aluminum alloy was solution treated at 470° C. for 2 h, quenching with 20° C. water, and subsequently maintained at 120° C. for 0.5 h and at 65° C. for 512 h in turn to complete the aging treatment.

### Property Measurement

The mechanical property measurement was performed on the samples after processing according to GB 6397-86.

1) The tensile strength test and elongation test were performed on the treated as-cast Al-6.82Si-0.34 Mg alloy in Embodiment 1 and Comparison Example 1; and the results were shown in Table 1.

TABLE 1
Properties comparison of the treated as-cast Al—6.82Si—0.34Mg
alloy in Embodiment 1 and Comparison Example 1

| | Ultimate tensile | Elongation |
|---|---|---|
| | strength (MPa) | (%) |
| Embodiment 1 | 320.3 | 15.2 |
| Comparison Example 1 | 311.2 | 13.6 |

It could be seen from Table 1 that the mechanical properties of the as-cast Al-6.82Si-0.34 Mg alloy sheet treated by the method of the present disclosure were better than those of the as-cast Al-6.82Si-0.34 Mg alloy sheet in the T614 condition.

2) The tensile strength test and elongation test were performed on the treated 7A62 aluminum alloy in Embodiment 2 and Comparison Example 2; and the results were shown in Table 2.

TABLE 1
Properties comparison of the treated 7A62 aluminum
alloy in Embodiment 2 and Comparison Example 2

| | Ultimate tensile | Elongation |
|---|---|---|
| | strength (MPa) | (%) |
| Embodiment 2 | 605.1 | 9.1 |
| Comparison Example 2 | 587.2 | 7.2 |

It could be seen from Table 2 that the mechanical properties of the 7A62 aluminum alloy sheet treated by the method of the present disclosure were better than those of the 7A62 aluminum alloy in the T6 condition.

3) The tensile strength test and elongation test were performed on the treated 7A52 aluminum alloy in Embodiment 3 and Comparison Example 3; and the results were shown in Table 3.

TABLE 1
Properties comparison of the treated 7A52 aluminum
alloy in Embodiment 3 and Comparison Example 3

| | Ultimate tensile | Elongation |
|---|---|---|
| | strength (MPa) | (%) |
| Embodiment 3 | 522.5 | 14.5 |
| Comparison Example 3 | 517.0 | 12.6 |

It could be seen from Table 3 that the mechanical properties of the 7A52 aluminum alloy sheet treated by the method described in the present disclosure were better than those of the 7A52 aluminum alloy sheet in the T614 condition.

4) The results of the hardness change with time of the aging treatment process described in Embodiment 3 and Comparison Example 3 were shown in FIG. 2; and

it could be seen from FIG. 2 that the peak aging time of the treated 7A52 aluminum alloy in Embodiment 3 was 250 h, and the hardness was 151.8 HV; and the peak aging time of the treated 7A52 aluminum alloy by the T614 treatment in Comparison Example 3 was 512 h, and the hardness was 149.1 HV. The peak aging time of the treated 7A52 aluminum alloy by the aluminum alloy treatment method of the present disclosure was earlier than that by the T614 process, and the hardness was higher than that by the T614 process.

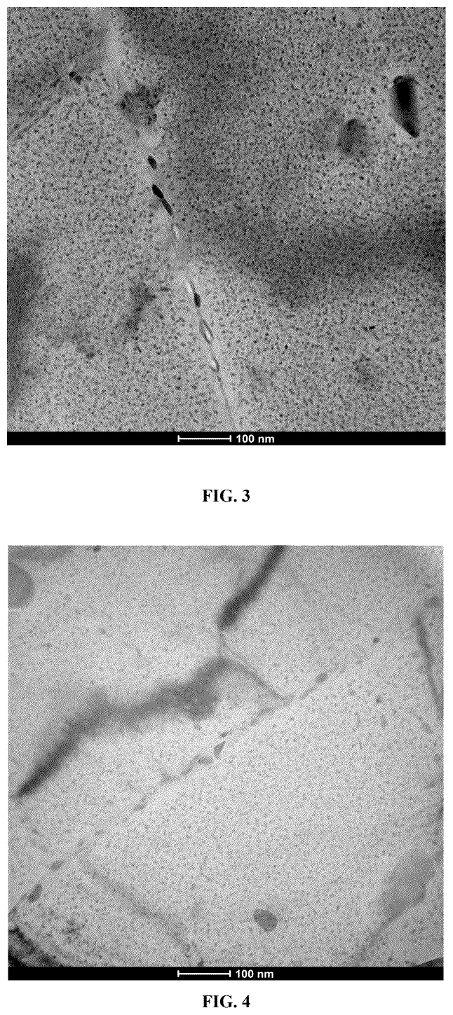

5) The microstructure of the treated 7A52 aluminum alloy in Embodiment 3 and Comparison Example 3 was detected by transmission electron microscope, the microstructure diagram of the treated 7A52 aluminum alloy in Embodiment 3 was shown in FIG. 3; and the microstructure diagram of the treated 7A52 aluminum alloy in Comparison Example 3 was shown in FIG. 4.

As shown in FIGS. 3 and 4, due to cryogenic treatment, the volume shrinkage and lattice constant of the alloy were decreased, the supersaturation of solute atoms in the Al matrix was increased, thereby increasing the power of solute atoms precipitation, while the subsequent sub-low temperature aging was beneficial to the nucleation of precipitated phase, so as to obtain fine and dispersed intragranular precipitated phase; and it could be seen from FIG. 3 that the aging precipitated phase of the treated 7A52 aluminum alloy by the method of the present disclosure was more dispersed and fine. At the same time, the cryogenic treatment caused the cold-induced compressive stress generated in the alloy to have the following effects, part of the compressive stress promoted the precipitation behavior, and the other part released stress through the grain boundary, resulting in an increase in the spacing between the n phases at the grain boundary, which was discontinuous distributed.

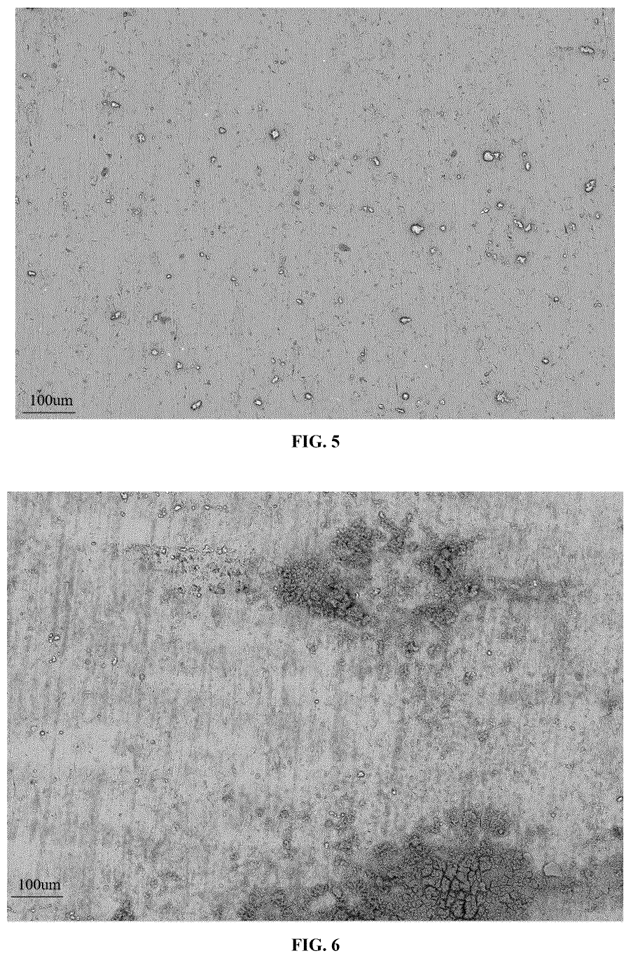

6) After the corrosion treatment was performed on the treated 7A52 aluminum alloy in Embodiment 3 and Comparison Example 3 by soaking in 3.5% NaCl solution for 72 h, the corrosion morphology was detected by scanning electron microscopy; the corrosion morphology diagram of the treated 7A52 aluminum alloy in Embodiment 3 was shown in FIG. 5; and the corrosion morphology diagram of the treated 7A52 aluminum alloy in Comparison Example 3 was shown in FIG. 6.

Comparing FIG. 5 and FIG. 6, it could be found that the surface of the 7A52 aluminum alloy treated with the present disclosure did not appear significant changes, while many corrosion pits and corrosion products were produced in Comparison Example 3, which indicated that the corrosion resisting property of the 7A52 aluminum alloy treated with the present disclosure was superior to that of the 7A52 aluminum alloy treated with the T614 process.

As can be seen from the above embodiments, the present disclosure provides a method of low-temperature heat treatment for the age-hardening aluminium alloy, the aluminium alloy after the solid solution and quenching treatment was subjected to short-term low-temperature cryogenic treatment first and then long-term sub-low-temperature aging treatment. The low-temperature cryogenic treatment causes dislocation multiplication and cold-induced compressive stress, so as to obtain fine intragranular precipitates and discontinuous precipitates at the grain boundary, which improves the tensile strength, elongation and corrosion resistance properties of the age-hardening aluminium alloy.

The above descriptions are only the preferred embodiments of the present disclosure. It is to be pointed out that those of ordinary skill in the art can also make several improvements and modifications without departing from the principle of the present disclosure, and such improvements and modifications shall fall within the protection scope of the present disclosure.

What is claimed is:

1. A method of low-temperature heat treatment for an age-hardening aluminium alloy with high properties, comprising the following steps:
performing a solid solution treatment, a quenching treatment, a low-temperature cryogenic treatment, and a sub-low-temperature aging treatment on an aluminum alloy in turn;
wherein a temperature of the low-temperature cryogenic treatment is −196° C. to −70° C., with a time of 0.5 h to 5 h; and a temperature of the sub-low-temperature aging treatment is 20° C. to 80° C., with a time of 120 h to 480 h.

2. The method according to claim 1, wherein the aluminum alloy comprises 2XXX series aluminum alloy, 6XXX series aluminum alloy or 7XXX series aluminum alloy.

3. The method according to claim 1, wherein a temperature of the solid solution treatment is 450° C. to 570° C., with a time of 0.5 h to 5 h.

4. The method according to claim 3, wherein a temperature of the solid solution treatment is 470° C. to 550° C., with a time of 1 h to 4 h.

5. The method according to claim 1, wherein a mode of the quenching treatment is water quenching, and a temperature of the water quenching is 5° C. to 30° C.

6. The method according to claim 1, wherein a temperature of the low-temperature cryogenic treatment is −196° C. to −100° C., with a time of 1 h to 4.5 h.

7. The method according to claim 6, wherein a temperature of the sub-low-temperature aging treatment is 50° C. to 75° C., with a time of 150 h to 300 h.
